(19) United States
(12) Patent Application Publication
(10) Pub. No.: US 2024/0003778 A1
(43) Pub. Date: Jan. 4, 2024

(54) DIAGNOSIS DEVICE, DIAGNOSIS METHOD, AND DIAGNOSIS PROGRAM

(71) Applicant: Mitsubishi Chemical Engineering Corporation, Tokyo (JP)

(72) Inventors: Koji KAWANO, Tokyo (JP); Akihiro MATSUKI, Tokyo (JP); Yuuki KUMANOMIDOU, Tokyo (JP); Shunji KIYOHARA, Tokyo (JP)

(21) Appl. No.: 18/452,387

(22) Filed: Aug. 18, 2023

Related U.S. Application Data
(63) Continuation of application No. PCT/JP2022/002204, filed on Jan. 21, 2022.

(30) Foreign Application Priority Data
Mar. 4, 2021 (JP) 2021-034644
Mar. 4, 2021 (JP) 2021-034645

(51) Int. Cl. G01M 7/02; G06T 11/20

(52) U.S. Cl. CPC G01M 7/025; G06T 11/206

(57) ABSTRACT

The diagnosis device executes: processing of determining a mean value and a standard deviation of reference data which is data in a reference period in the time series data and then calculating a normalized value of comparison data which is data in a comparison target period in the time series data from the mean value and the standard deviation; processing of executing processing of grouping pieces of data of the plurality of sensors in order of a magnitude relationship between the pieces of data for each of the reference data and the comparison data; and processing of outputting a screen having a diagram which visually shows the normalized value of the comparison data and a table which represents a correspondence between ranking of a group of the magnitude relationship between the pieces of data and each of the plurality of sensors for each of the reference data and the comparison data.

### CROSS-REFERENCE TO RELATED APPLICATION

This is a continuation of International Application PCT/JP2022/002204 filed on Jan. 21, 2022, and designated the U.S., and claims priority from Japanese Patent Application 2021-034644 which was filed on Mar. 4, 2021 and Japanese Patent Application 2021-034645 which was filed on Mar. 4, 2021, the entire contents of which are incorporated herein by reference.

### TECHNICAL FIELD

The present invention relates to a diagnosis device, a diagnosis method, and a diagnosis program.

### BACKGROUND ART

In recent years, the technique for diagnosing secular changes of various devices is widely used (see, e.g., PTL 1).

### DOCUMENTS OF PRIOR ARTS

### Patent Document

[PTL 1] Japanese Patent No. 6801131

### SUMMARY OF THE INVENTION

### Problems to be Solved by the Invention

As an example of a diagnosis method of devices, for example, changes of a vibration level before and after maintenance work of equipment or the like are compared with each other and it is determined that the maintenance work is properly performed in some cases. In such a diagnosis method, for example, pieces of vibration data of a temporary or permanent vibration sensor before and after a start of the maintenance work are collected and analysis is performed. However, currently, an indicated value of the sensor which is checked visually by a worker is recorded and it is determined whether or not a significant change before and after the maintenance work is present or whether or not the indicated value falls within a reference value in general, and it is not possible to easily identify a change which can not be grasped unless data is analyzed specifically. In addition, in equipment in which a plurality of processes are present in one operation cycle, the indicated value differs from one process to another in many cases, and the indicated value in the subsequent process differs according to a status in the preceding process routinely.

To cope with this, a first problem to be solved by the present invention is to allow pieces of time series data indicative of a status of equipment to be compared with each other easily for each period. In addition, a second problem to be solved by the present invention is to allow pieces of time series data indicative of a status of equipment to be compared with each other easily for each operation cycle.

### Means for Solving the Problems

In order to solve the first problem described above, the present invention outputs a screen having a diagram which visually shows a normalized value of comparison data and a table which represents a correspondence between ranking of groups of a magnitude relationship between pieces of data and a sensor for each of reference data and the comparison data.

Specifically, the present invention is a diagnosis device for diagnosing a status of equipment, including: a memory which stores time series data of a plurality of sensors indicative of the status of the equipment; and a processor which determines change of the status of the equipment from the time series data, wherein the processor executes: processing of determining a mean value and a standard deviation of reference data which is data in a reference period in the time series data and then calculating a normalized value of comparison data which is data in a comparison target period in the time series data from the mean value and the standard deviation; processing of executing processing of grouping pieces of data of the plurality of sensors in order of a magnitude relationship between the pieces of data for each of the reference data and the comparison data; and processing of outputting a screen having a diagram which visually shows the normalized value of the comparison data and a table which represents a correspondence between ranking of a group of the magnitude relationship between the pieces of data and each of the plurality of sensors for each of the reference data and the comparison data.

Herein, the normalized value is a value indicative of a degree of dispersion with respect to a reference value, and can be applied to, e.g., the degree of dispersion of a vibration level in a comparison target period with respect to the vibration level in a reference period, or the degrees of dispersion of other various physical quantities.

According to the above-described diagnosis device, the degree of dispersion of the time series data of the sensor in the comparison target period with respect to the time series data of the sensor in the reference period is visually displayed, and the correspondence between the ranking of groups of the magnitude relationship between the pieces of data and the sensor is represented for each of the reference data and the comparison data. Therefore, it becomes possible to easily compare the change of the time series data between the reference period and the comparison target period.

Note that the sensor may be a vibration sensor, and the time series data may be data of a vibration level of the equipment. Vibration generated by the equipment in operation is usually continuous. Therefore, when the above-described diagnosis device is used with the data of the vibration sensor, the diagnosis device is more effective in the comparison of the change of the time series data between the reference period and the comparison target period.

In addition, the processor may divide the reference data into a predetermined number of pieces of the reference data and divide the comparison data into a predetermined number of pieces of the comparison data, and may calculate the mean value and the standard deviation of the reference data and the normalized value of the comparison data from a difference between a maximum value and a minimum value of the pieces of the data in each division period. According to such a calculation method, it is possible to reduce a calculation load related to processing of data.

In addition, the processor may execute, for each of the reference data and the comparison data, processing of grouping in the order of the magnitude relationship between the pieces of data by grouping the plurality of sensors into a same group and a different group according to whether or not the pieces of data of the plurality of sensors fall within a range having a standard deviation in normal distribution as a reference. According to this, it is possible to group the pieces of data into the number of groups which is trouble-free practically.

Further, the present invention can also be viewed from an aspect of a method. The present invention may be, e.g., a diagnosis method for diagnosing a status of equipment, wherein a computer executes: processing of determining a mean value and a standard deviation of reference data which is data in a reference period in time series data of a plurality of sensors indicative of the status of the equipment and then calculating a normalized value of comparison data which is data in a comparison target period in the time series data from the mean value and the standard deviation; processing of executing processing of grouping pieces of data of the plurality of sensors in order of a magnitude relationship between the pieces of data for each of the reference data and the comparison data; and processing of outputting a screen having a diagram which visually shows the normalized value of the comparison data and a table which represents a correspondence between ranking of a group of the magnitude relationship between the pieces of data and each of the plurality of sensors for each of the reference data and the comparison data.

In addition, the present invention can also be viewed from an aspect of a program. The present invention may be, e.g., a diagnosis program for diagnosing a status of equipment which causes a computer to execute: processing of determining a mean value and a standard deviation of reference data which is data in a reference period in time series data of a plurality of sensors indicative of the status of the equipment and then calculating a normalized value of comparison data which is data in a comparison target period in the time series data from the mean value and the standard deviation; processing of executing processing of grouping pieces of data of the plurality of sensors in order of a magnitude relationship between the pieces of data for each of the reference data and the comparison data; and processing of outputting a screen having a diagram which visually shows the normalized value of the comparison data and a table which represents a correspondence between ranking of a group of the magnitude relationship between the pieces of data and each of the plurality of sensors for each of the reference data and the comparison data.

Further, in order to solve the second problem described above, in the present invention, a group number which is selected in the order of magnitude of a representative value indicative of a relative relationship of data in each unit period to data in all periods in a specific operation cycle is assigned to the data in each unit period, and a screen of a graph in which a plurality of graphs which are obtained by plotting the group number in chronological order of each unit period and correspond to a plurality of operation cycles are shown so as to overlap each other is output.

Specifically, the present invention is a diagnosis device for diagnosing a status of equipment in which a plurality of processes are present in one operation cycle, the diagnosis device including: a memory which stores time series data of a plurality of sensors indicative of the status of the equipment; and a processor which determines change of the status of the equipment from the time series data, wherein the processor executes: calculation processing of dividing data from a start to an end of a specific operation cycle in the time series data for each of unit periods and calculating a representative value indicative of a relative relationship of data in each unit period to data in all periods in the specific operation cycle for each of the unit periods; grouping processing of assigning a group number which is selected in order of magnitude of the representative value to the data in each of the unit periods; and output processing of outputting a screen of a graph in which a plurality of graphs which are obtained by plotting the group number assigned to the data in each of the unit periods in chronological order of each of the unit periods and correspond to a plurality of operation cycles are shown so as to overlap each other.

Herein, the group number is a group name assigned to data in each unit period and is not limited to a number, but the number which can be set on the vertical axis of the graph easily is preferable.

According to the above-described diagnosis device, with regard to the equipment in which the plurality of processes are present in one operation cycle, it becomes possible to easily grasp the relative relationship of each unit period between the data from the start to the end of the specific operation cycle and the data from the start to the end of another operation cycle with the graph. Therefore, even in the case of the equipment in which the plurality of processes are present in one operation cycle, it becomes possible to easily grasp the change of the status of the equipment.

Note that the processor may calculate a value obtained by squaring a normalized value indicative of magnitude of a degree of dispersion of the data in each of the unit periods and totalizing the value obtained by the squaring which corresponds to the plurality of sensors as the representative value for each of the unit periods in the calculation processing. In this case, the processor may calculate a mean value Δ of each of the unit periods for a difference between a maximum value and a minimum value which are calculated individually after the data in each of the unit periods is divided into a predetermined number of pieces of the data and all mean values μ and all standard deviations σ in the specific operation cycle, and calculate the normalized value by using the mean value Δ, the mean values μ, and the standard deviations σ.

According to this, it becomes possible to calculate a value indicative of the relative relationship of the data in each unit period to the data in all periods in the specific operation cycle as the representative value. Note that the normalized value is a value indicative of the degree of dispersion with respect to the reference value, and can be applied to, e.g., the degree of dispersion of the vibration level in the comparison target period with respect to the vibration level in the reference period, or the degrees of dispersion of other various physical quantities.

In addition, the processor may determine that the representative values of pieces of data in a specific unit period which is one of the individual unit periods and pieces of data in another specific unit period whose ranges between minimum values and maximum values of differences of magnitude of dispersion of the pieces of data overlap each other are at a same level, and assign a same group number to each of the pieces of data of the unit periods in the grouping processing. According to this, it is possible to group the pieces of data into the number of groups which is trouble-free practically.

Further, each of the plurality of sensors may be a vibration sensor, and the time series data may be data of a vibration level of the equipment. Vibration generated by the equipment in operation is usually continuous. Therefore, when the above-described diagnosis device is used with the data of the vibration sensor, the diagnosis device is suitable for grasping the change of the status of the equipment.

In addition, the present invention can also be viewed from an aspect of a method. The present invention may be, e.g., a diagnosis method for diagnosing a status of equipment in which a plurality of processes are present in one operation cycle, wherein a computer executes: calculation processing of dividing data from a start to an end of a specific operation cycle in time series data of a plurality of sensors indicative of the status of the equipment for each of unit periods and calculating a representative value indicative of a relative relationship of data in each unit period to data in all periods in the specific operation cycle for each of the unit periods; grouping processing of assigning a group number which is selected in order of magnitude of the representative value to the data in each of the unit periods; and output processing of outputting a screen of a graph in which a plurality of graphs which are obtained by plotting the group number assigned to the data in each of the unit periods in chronological order of each of the unit periods and correspond to a plurality of operation cycles are shown so as to overlap each other.

Further, the present invention can also be viewed from an aspect of a program. The present invention may be, e.g., a diagnosis program for diagnosing a status of equipment in which a plurality of processes are present in one operation cycle, the diagnosis program causing a computer to execute: calculation processing of dividing data from a start to an end of a specific operation cycle in time series data of a plurality of sensors indicative of the status of the equipment for each of unit periods and calculating a representative value indicative of a relative relationship of data in each unit period to data in all periods in the specific operation cycle for each of the unit periods; grouping processing of assigning a group number which is selected in order of magnitude of the representative value to the data in each of the unit periods; and output processing of outputting a screen of a graph in which a plurality of graphs which are obtained by plotting the group number assigned to the data in each of the unit periods in chronological order of each of the unit periods and correspond to a plurality of operation cycles are shown so as to overlap each other.

### Effects of the Invention

According to the diagnosis device, the diagnosis method, and the diagnosis program described above, it becomes possible to easily compare pieces of the time series data indicative of the status of the equipment for each period. Alternatively, according to the diagnosis device, the diagnosis method, and the diagnosis program described above, even in the case of the equipment in which the plurality of processes are present in one operation cycle, it becomes possible to easily compare pieces of the time series data indicative of the status of the equipment for each operation cycle.

### BRIEF DESCRIPTION OF THE DRAWINGS

FIG. 1 is a view showing an example of a system configuration of a diagnosis system according to a first embodiment.

FIG. 2 is a view showing an example of a processing flow implemented by a computer.

FIG. 3 is a view for explaining a processing content of vibration data in a reference period.

FIG. 4 is a view for explaining a processing content of vibration data in a comparison target period.

FIG. 5 is a view showing, as an example, a correlation between magnitude of a vibration level detected by each sensor and occurrence frequency.

FIG. 6 is a view for explaining a concept of a correlation between the vibration levels of the sensor.

FIG. 7 is a view showing an example of calculation of a mean value and a standard deviation.

FIG. 8 is a view showing an example of calculation of a normalized value.

FIG. 9 is a view showing examples of sorting and grouping.

FIG. 10 is a view showing a first example of a screen of a comparison result of vibration data.

FIG. 11 is a view showing a second example of the screen of the comparison result of the vibration data.

FIG. 12 is a view showing a third example of the screen of the comparison result of the vibration data.

FIG. 13 is a view showing an example of a system configuration of a diagnosis system according to a second embodiment.

FIG. 14 is a view showing an example of a processing flow implemented by a computer.

FIG. 15 is a view for explaining a processing content of vibration data in a specific operation cycle.

FIG. 16 is a view for explaining sorting of a representative value and assignment of a group number.

FIG. 17 is a view showing, as an example, a correlation between magnitude of a vibration level detected by each sensor and occurrence frequency.

FIG. 18 is a view for explaining a concept of a correlation between the vibration levels of the sensor.

FIG. 19 is a view in which sorting of the group number in a specific operation cycle and drawing processing of a graph are imaged.

FIG. 20 is a view in which mixing processing is represented with an image.

FIG. 21 is a graph in which graphs of operation cycles serving as comparison targets are shown such that the graphs can be compared with a base pattern.

### MODE FOR CARRYING OUT THE INVENTION

Hereinbelow, a first embodiment will be described. The first embodiment shown below is shown by way of example only and the technical scope of the present disclosure is not limited to the following implementation.

<Hardware Configuration>

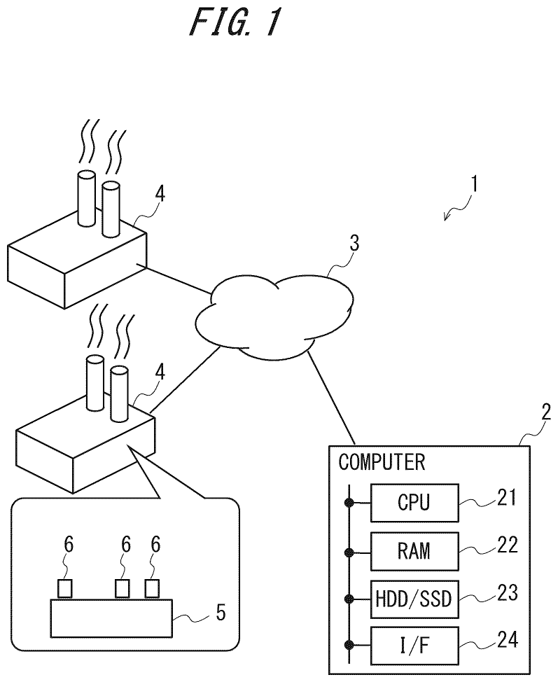

FIG. 1 is a view showing an example of a system configuration of a diagnosis system 1 according to the first embodiment. The diagnosis system 1 is a system which diagnoses equipment 5 installed in a facility 4. The diagnosis system 1 is a system which uses a state of vibration of the equipment 5 in a specific period as a reference and presents relative state change of vibration of the equipment 5 in other periods. The diagnosis system 1 can be applied to, e.g., comparison before and after periodic maintenance work of the equipment 5, comparison between the time of test operation and the time of regular operation, and relative state change of vibration at other various timings. Therefore, the diagnosis system 1 acquires data related to vibration of the equipment 5 with a temporary or permanent vibration sensor 6 which is mounted to the equipment 5, and performs diagnosis of the equipment 5 by analyzing the data. Examples of the equipment 5 of the facility 4 diagnosed by the diagnosis system 1 include various pieces of equipment which can generate vibration during operation. Examples of such equipment 5 include production equipment of medicine and industrial products, power generation equipment, transport machinery, and other various pieces of equipment.

The vibration sensor 6 which detects the vibration of the equipment 5 transmits data with wired or wireless communication. The data transmitted from the vibration sensor 6 is uploaded to a cloud 3 via a computer or the like which is installed in the facility 4. A computer 2 (an example of “diagnosis device” in the present application) analyzes the data uploaded to the cloud 3, and performs abnormality detection of the equipment 5 or the like. The computer 2 is an electronic computer having a CPU 21, a memory 22, a storage 23, and a communication interface 24, and executes various steps of processing described later by executing a computer program which is read from the storage 23 and is loaded into the memory 22. The computer 2 may be a computer installed at a place remote from the facility 4 or may also be a computer installed in the facility 4.

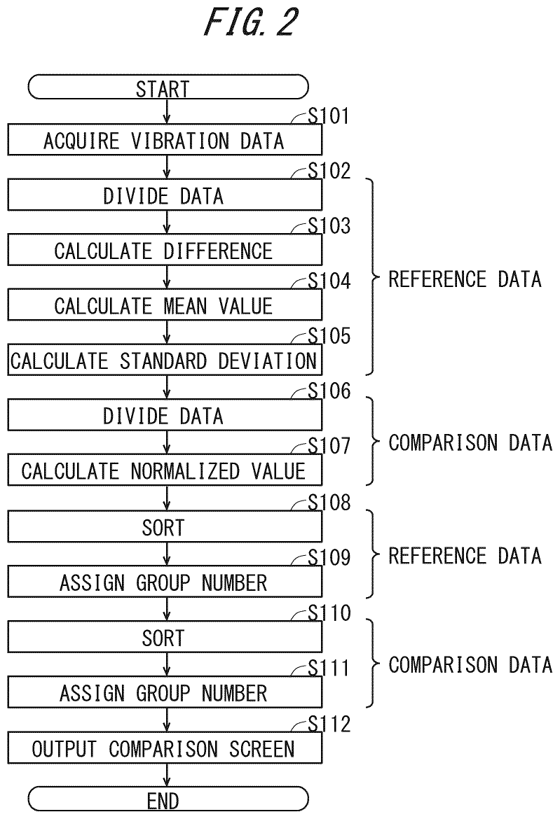

When the computer 2 executes the computer program, the computer 2 implements the following processing. FIG. 2 is a view showing an example of a processing flow implemented by the computer 2. When the computer 2 executes the computer program, the computer 2 implements a series of the processing flow from Step S101 to Step S112 shown in FIG. 2. Hereinafter, the processing flow implemented by the computer 2 will be described.

First, the computer 2 performs acquisition of vibration data uploaded to the cloud 3 (S101). That is, the computer 2 stores vibration data measured by the vibration sensor 6 in the memory 22. The vibration data is data of a physical quantity related to vibration, and examples thereof include various vibration levels such as the magnitude of amplitude. The vibration data stored in the memory 22 may also be real-time data which is successively accumulated during operation of the computer 2. The vibration data may also be data which is directly transmitted to the computer 2 from the vibration sensor 6 instead of data uploaded to the cloud 3.

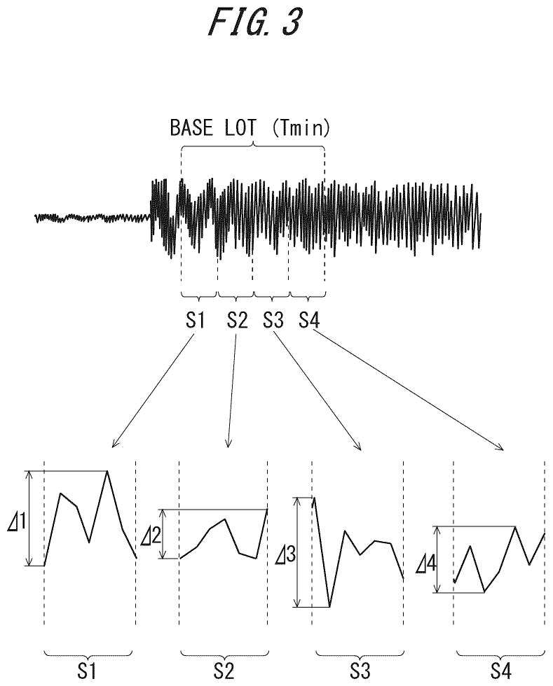

Next, the computer 2 extracts data in a reference predetermined period (T min.) from the vibration data, and divides the extracted vibration data into a predetermined number of pieces of vibration data (S102). FIG. 3 is a view for explaining a processing content of the vibration data in the reference period. While it is possible to determine, from among pieces of vibration data, which one of the pieces of vibration data in a certain period is to be used as reference vibration data (BASE LOT) in various ways, for example, in the case where comparison before and after periodic maintenance work is performed, it is preferable to use the vibration data before the maintenance work is started as the data in the reference predetermined period. In addition, the number of pieces of data obtained by the division can be appropriately determined according to calculation ability or diagnosis accuracy of the computer 2 and, herein, a description will be made by using, as an example, the case where the reference vibration data is divided into quarters which are pieces of vibration data S1 to S4.

Next, the computer 2 calculates a difference obtained by subtracting a minimum value from a maximum value for each of the four pieces of the vibration data S1 to S4 obtained by the division (S103). Hereinafter, it is assumed that the respective differences of the four pieces of vibration data S1 to S4 are differences Δ1 to Δ4. The computer 2 performs the calculation of the difference of each of the pieces of vibration data obtained by the division for, e.g., data of all of the sensors. A typical vibration sensor usually outputs pieces of vibration data of three axes of X, Y, and Z. Therefore, in the case where the vibration sensor 6 outputs the respective vibrations of the three axes in this manner, the computer 2 performs the calculation of the difference of each piece of vibration data obtained by the division for three pieces of vibration data corresponding to one vibration sensor 6. While the vibration sensor 6 outputs three pieces of vibration data in this manner, even in the case where one of the outputs of the three axes which are detected by the vibration sensor 6 is meant, there are cases where, hereinafter, the one of the outputs of the three axes is referred to as “the output of the sensor” for the convenience of description.

Next, the computer 2 calculates a mean value of the differences Δ1 to Δ4 based on the following formula (S104). Hereinafter, it is assumed that the mean value of the differences Δ1 to Δ4 in the predetermined period is a mean value ΔBASE.

(Δ1+Δ2+Δ3+Δ4)/4=Δ_{BASE} [Math. 1]

Next, a standard deviation σ of the vibration data in the reference predetermined period is calculated (S105). The standard deviation σ of the vibration data in the predetermined period is calculated based on the following formula. Note that p in the formula shown below is the mean value ΔBASE calculated in Step S104.

$$μ = {Δ}_{BASE} \\ {σ}^{2} = \frac{1}{4 - 1} {\sum }_{i = 1}^{4} {( {Δ}_{i} - μ )}^{2} \qquad [ Math . 2 ]$$

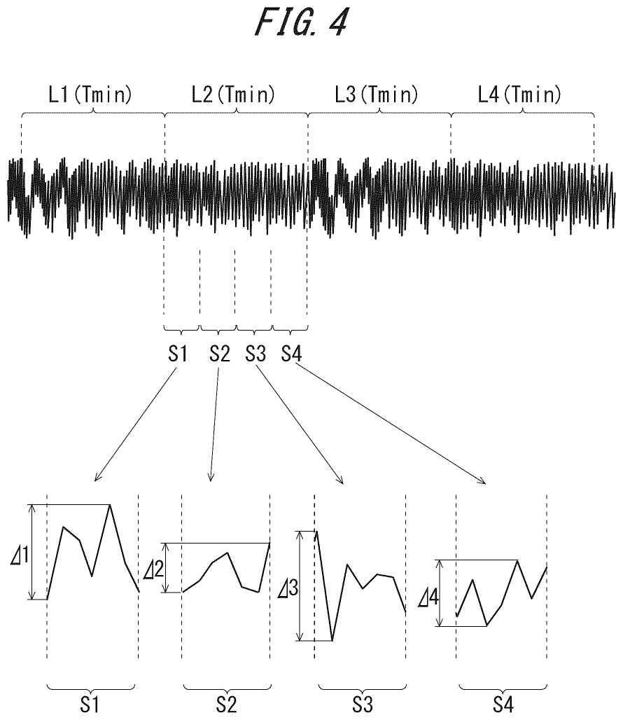

With the foregoing, processing of the vibration data in the reference predetermined period is completed. Next, processing of vibration data in a comparison target period will be described. FIG. 4 is a view for explaining a processing content of the vibration data in the comparison target period. After the processing in Step S105 is completed, data in a comparison target predetermined period (T min.) is extracted from the vibration data, and the extracted vibration data is divided into a predetermined number of pieces of vibration data (S106). It is preferable that the vibration data extracted as the comparison target corresponds to the vibration data in the reference predetermined period. For example, in the case where the vibration data in the reference predetermined period is the vibration data in a period from a start of manufacturing of a predetermined product by the equipment 5 to an end of the manufacturing of the predetermined product, the vibration data extracted as the comparison target is preferably the vibration data in the period from the start of the manufacturing of the predetermined product by the equipment 5 to the end of the manufacturing thereof. In addition, in the case where the manufacturing of the predetermined product is repeatedly performed in the equipment 5, it is preferable to extract the vibration data in each period from the start of the manufacturing to the end of the manufacturing. FIG. 4 shows an example in which an operation similar to that in the reference predetermined period is repeated at least four times or more in the equipment 5, and pieces of vibration data L1 to L4 corresponding to four periods each having the same length as that of the predetermined period (T min.) are extracted. In addition, the number of pieces of vibration data obtained by division when each of the pieces of vibration data L1 to L4 is divided is the same as the number of pieces of vibration data obtained by the division in Step S102.

Next, a normalized value Θ of the vibration data in the comparison target period is calculated (S107). The normalized value Θ is calculated for each of the pieces of vibration data L1 to L4, and hence, hereinafter, in the case where a specific normalized value Θ is meant, a description is made together with corresponding marks L1 to L4 (for example, the normalized value Θ of the piece of vibration data L2 is described as “normalized value ΘL2”). The normalized value Θ is calculated by the following processing.

That is, similarly to the processing in Step S102 described above, each of the pieces of vibration data L1 to L4 is divided into a predetermined number of pieces of vibration data. FIG. 4 shows, as an example, the case where the piece of vibration data L2 is divided into quarters which are pieces of vibration data S1 to S4. Subsequently, similarly to the processing in Step S103 described above, the difference obtained by subtracting the minimum value from the maximum value is calculated for each of the four pieces of vibration data S1 to S4 obtained by the division. Then, similarly to the processing in Step S104 described above, the mean value Δ of the differences Δ1 to Δ4 is calculated. The mean value Δ is calculated for each of the pieces of vibration data L1 to L4, and hence, hereinafter, in the case where a specific mean value Δ is meant, a description is made together with corresponding marks L1 to L4 (for example, the mean value Δ of the piece of vibration data L2 is described as “mean value ΔL2”). Subsequently, the normalized value Θ is calculated for each of the pieces of vibration data L1 to L4 based on the following formula.

$$normalized value Θ = \frac{Δ - μ}{σ} \qquad [ Math . 3 ]$$

With a series of steps of the processing described above, the normalized value Θ is calculated as a degree of dispersion of a vibration level in the comparison target period with respect to the reference predetermined period.

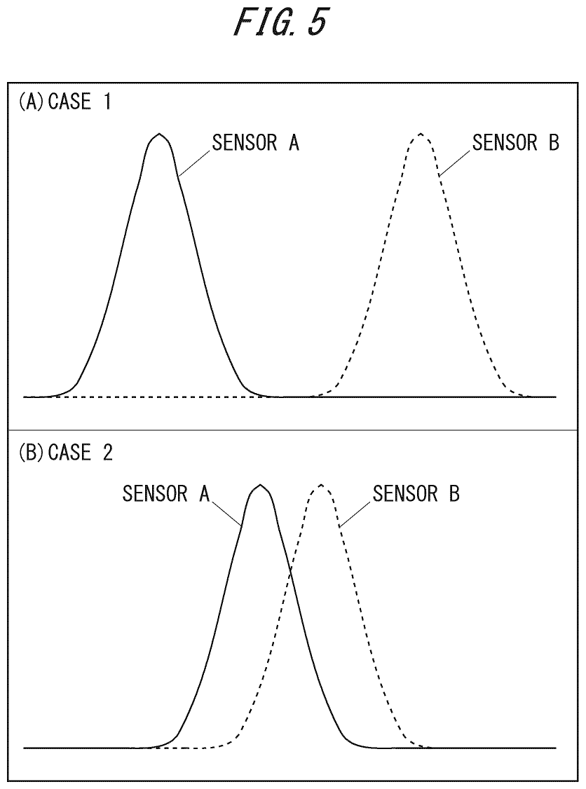

Next, a description will be given of processing for evaluating a correlation between sensors. FIG. 5 is a view showing, as an example, a correlation between the magnitude of the vibration level detected by each sensor and occurrence frequency. In each graph in FIG. 5, the horizontal axis indicates the magnitude of the vibration level, and the vertical axis indicates the occurrence frequency. In FIG. 5, a graph shown in (A) shows, as an example, the case where the magnitudes of the vibration levels detected by two sensors are clearly different from each other. In addition, in FIG. 5, a graph shown in (B) shows, as an example, the case where the magnitudes of the vibration levels detected by the two sensors are relatively close to each other. In the case where the magnitudes of the vibration levels detected by the two sensors are clearly different from each other, as shown in FIG. 5(A), it is possible to clearly determine a relative magnitude relationship between pieces of the vibration data measured by the individual sensors. On the other hand, in the case where the magnitudes of the vibration levels detected by the two sensors are relatively close to each other, as shown in FIG. 5(B), there are cases where it is not possible to clearly determine the relative magnitude relationship between pieces of the vibration data measured by the individual sensors. To cope with this, in order to facilitate comparison of the relative magnitude relationship between pieces of the vibration data measured by the individual sensors, the computer 2 performs the following processing.

First, the computer 2 sorts (rearranges) the mean values ΔBASE in Step S104 which are calculated for the outputs of all of the sensors in the reference vibration data (BASE LOT) in ascending order (S108). Subsequently, group numbers are assigned to the individual sensors sorted in the order of arrangement of the mean values ΔBASE (S109). In addition, the mean values Δ in Step S107 which are calculated for the outputs of all of the sensors in the vibration data in the comparison target period are sorted in ascending order (5110). Subsequently, group numbers are assigned to the individual sensors sorted in the order of arrangement of the mean values Δ (S111). Then, a screen of a comparison result of the vibration data is output (S112). With regard to comparison of the magnitude relationship between the vibration levels detected by the individual sensors, when the comparison between the vibration levels in the same detection direction (axis) is performed, it is easy to determine which part of the equipment is a cause in the case where the magnitude relationship is switched. To cope with this, in the present embodiment, sorting or comparison between the group numbers is performed on the mean values or the group numbers in the same detection direction (axis) (e.g., the X-axis, the Y-axis, or the Z-axis).

When the group number assigned by the above processing is subdivided, the number of sensors of which the magnitude relationship is switched becomes extremely large, and hence it becomes difficult for a user who has viewed the screen output in Step S112 to grasp change between the reference vibration data (BASE LOT) and the vibration data in the comparison target period. To cope with this, in the present embodiment, by performing the assignment of the group number in the above processing according to the following concept, the grasping of the change between the reference vibration data (BASE LOT) and the vibration data in the comparison target period is facilitated.

That is, in the case of CASE 1 shown in (A) in FIG. 5, it can be said that, with regard to a correlation between the vibration level of a sensor A and the vibration level of a sensor B, A is clearly smaller than B (A<B). Therefore, in the present embodiment, with regard to CASE 1 in which the magnitude relationship between the vibration levels is clear, the sensor A and the sensor B are defined as different groups. In addition, in the case of CASE 2 shown in (B) in FIG. 5, it can be said that, with regard to the correlation between the vibration level of the sensor A and the vibration level of the sensor B, there are cases where A is not more than B (A≤B) or A is not less than B (A≥B). Therefore, in the present embodiment, with regard to CASE 2 in which the magnitude relationship between the vibration levels is not clear, the sensor A and the sensor B are defined as the same group.

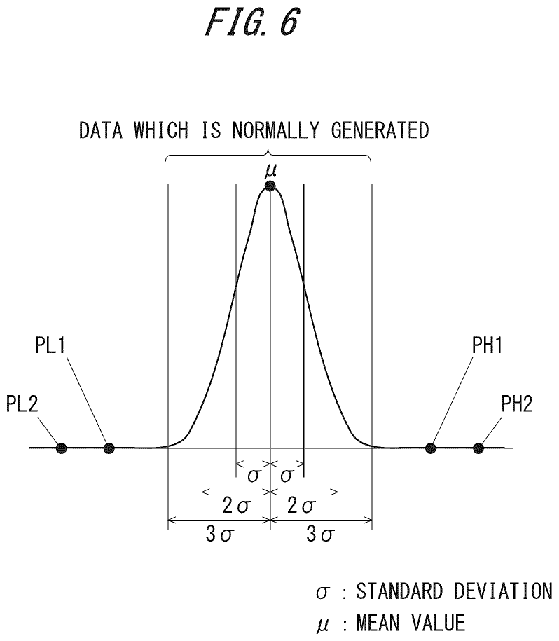

FIG. 6 is a view for explaining a concept of a correlation between the vibration levels of the sensors. In a graph in FIG. 6, the horizontal axis indicates the magnitude of the vibration level, and the vertical axis indicates the occurrence frequency. The occurrence frequency of the vibration level output by a specific sensor basically conforms to normal distribution in which a mean value p is at the apex. Each of vibration levels PH1 and PL1 shown in the graph in FIG. 6 is data which seldom occurs (a value in a rare case). In addition, each of vibration levels PH2 and PL2 shown in the graph in FIG. 6 is abnormal data (outlier). The probability that the vibration level exceeds two standard deviations σ from the mean value μ (μ±2 σ) is 4.5%, and hence the probability that the magnitude relationship between the vibration levels of two sensors which are compared with each other is reversed is about 0.05% (2.25%×2.25%), which is an extremely low probability. To cope with this, in the present embodiment, when the value of μ+2 σ in the vibration level of the specific sensor is smaller than the value of μ−2 σ in the vibration level of another sensor, in principle, both sensors are handled as different groups.

Note that setting of a threshold value can be appropriately changed according to data of the vibration level. For example, an area in a range of ±σ is 68.3%, an area in a range of +2 σ is 95.5%, and an area in a range of ±3 σ is 99.7%, and hence an appropriate threshold value in the number of sensors or the degree of dispersion of data of the vibration level is set as the threshold value used in grouping.

Incidentally, in the present embodiment, when the value of μ+2 σ in the vibration level of the specific sensor is smaller than the value of μ−2 σ in the vibration level of another sensor, in principle, both sensors are handled as different groups, but exceptional handling is also performed. That is, when the number of samples of data which serve as sources when the mean value p or the standard deviation σ is calculated is small, data cannot represent normal distribution. Therefore, there are cases where μ+2 σ (or μ±σ, μ±3 σ) exceeds the minimum value or the maximum value of actual data. To cope with this, in the present embodiment, the following processing is performed in case that a value which does not conform to a state of such an actual vibration level is calculated.

That is, in the case where it is assumed that the minimum value in a target measurement period is ρ, and the maximum value in the target measurement period is η, ρ or η is set by the computer 2 in the case where μ+2 σ is exceeded. A description will be made by using, as an example, the case where five sensors A, B, C, D, and E are assumed to be provided and determination is performed by using 2 σ. For example, it is assumed that, as a result of sorting the mean values of pieces of vibration data of the five sensors in the X-axis direction, the mean values are arranged in the order of ΔAx, ΔBx, ΔCx, ΔDx, and ΔEx in ascending order. In the following formula, G represents a group number, the group number having the minimum mean value Δ is No. 1, and No. 2, 3, . . . are used sequentially as the group numbers.

$${G}_{Ax} = 1 \\ if {Δ}_{Ax} + 2 {σ}_{Ax} > {η}_{Ax} then {Δ}_{Ax} + 2 {σ}_{Ax} = {η}_{Ax} \\ if {Δ}_{Bx} - 2 {σ}_{Bx} < {ρ}_{Bx} then {Δ}_{Bx} - 2 {σ}_{Bx} = {ρ}_{Bx} \\ if {Δ}_{Ax} + 2 {σ}_{Ax} < {Δ}_{Bx} - 2 {σ}_{Bx} then \\ {G}_{Bx} \neq {G}_{Ax} else {G}_{Bx} = {G}_{Ax} \\ ⋮ \\ if {Δ}_{Dx} + 2 {σ}_{Dx} < {Δ}_{Ex} - 2 {σ}_{Ex} then \\ {G}_{Ex} \neq {G}_{Dx} else {G}_{Ex} = {G}_{Dx} \qquad [ Math . 4 ]$$

In Step S109 and Step S111 described above, the computer 2 performs the assignment of the group number conforming to the above formula. Subsequently, in Step S112 described above, the computer 2 outputs a screen in which the group number of each sensor in the reference vibration data (BASE LOT) and the group number of each sensor in the vibration data in the comparison target period are compared with each other.

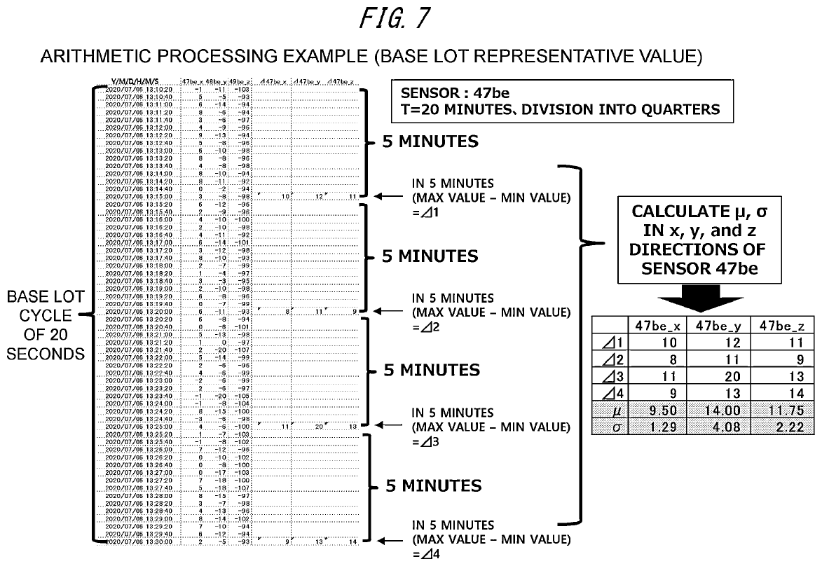

FIG. 7 is a view showing an example of the calculation of the mean value ΔBASE and the standard deviation G. FIG. 7 shows an image of processing (S102 to S105) in which vibration data of twenty minutes is used as reference data and the mean value ΔBASE (=μ) and the standard deviation σ are calculated for each of pieces of vibration data of five minutes obtained by dividing the reference data into quarters.

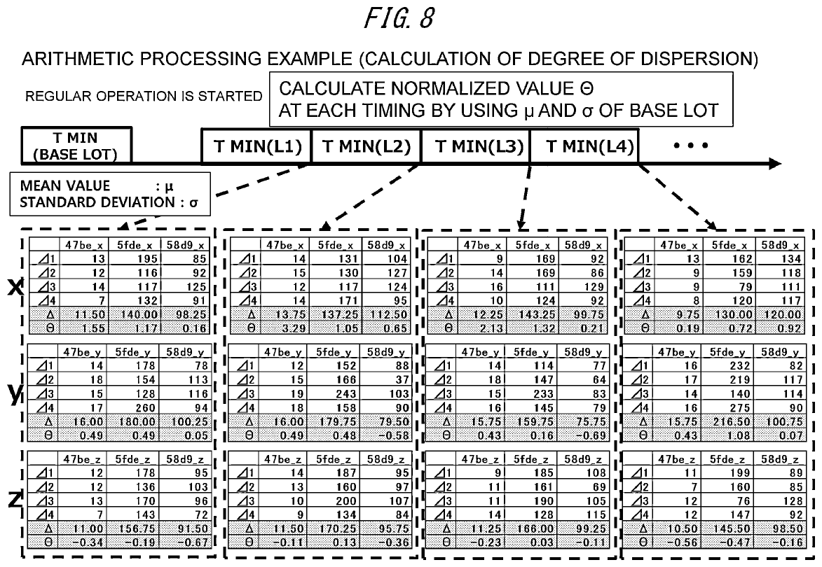

FIG. 8 is a view showing an example of the calculation of the normalized value 8. FIG. 8 shows an image of processing (S106 to S107) in which the normalized value Θ is calculated for each of the pieces of vibration data L1 to L4 of twenty minutes which serve as comparison targets.

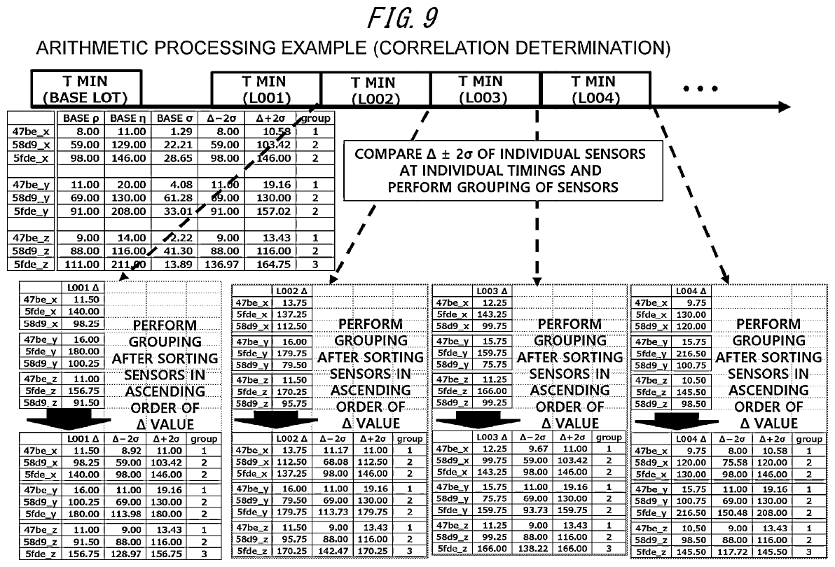

FIG. 9 is a view showing examples of sorting and grouping. FIG. 9 shows an image of processing (S108 to 5111) in which the mean values Δ are sorted (rearranged) in ascending order and the group numbers are assigned for the outputs of all of the sensors in the reference vibration data (BASE LOT) and the comparison target vibration data.

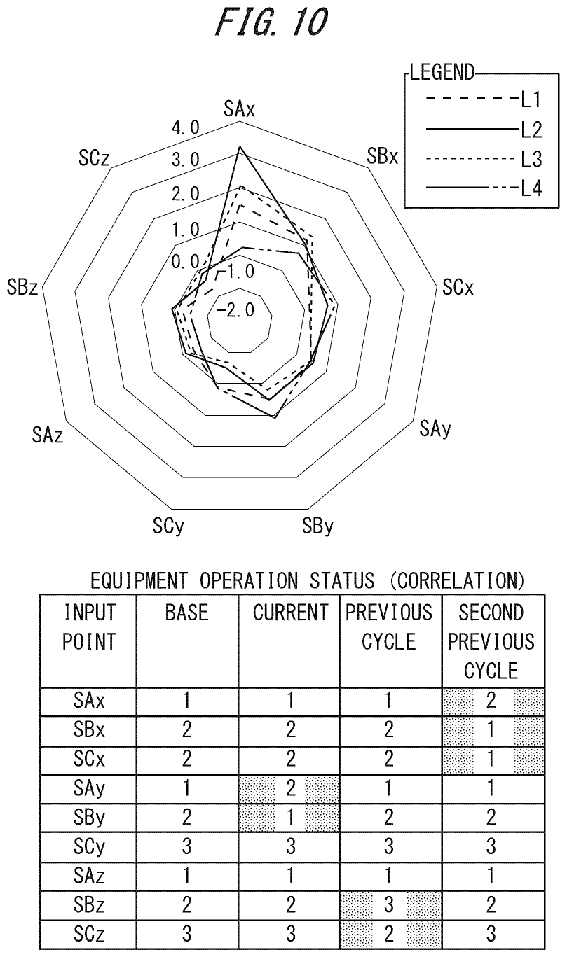

FIG. 10 is a view showing a first example of a screen of a comparison result of vibration data. FIG. 10 shows, as an example, a screen which draws a radar chart which shows the normalized values 8 of nine sensors (three sensors 6 in the X-axis, the Y-axis, and the Z-axis) for all of four pieces of vibration data L1 to L4, and a table which shows a relationship between the group number of each sensor in the reference vibration data and the group number of each sensor in the vibration data in the comparison target period. The radar chart shown in FIG. 10 shows the normalized value Θ, and hence a part having the normalized value Θ of zero corresponds to a part of the reference vibration data. In addition, in the table shown in FIG. 10, a part having the group number which is different from the group number of the reference vibration data is hatched and displayed such that the part having the group number different from the group number of the reference vibration data can be easily recognized.

When the screen shown in FIG. 10 is displayed in the computer 2, the user having viewed the screen can easily grasp the change between the reference vibration data (BASE LOT) and the vibration data in the comparison target period. For example, from the radar chart shown in FIG. 10, it can be seen that, in a sensor SAx, the degree of dispersion of each of the pieces of vibration data L1 to L3 is high as compared with the vibration data in the reference period. Therefore, it can be seen that some change is present in a part related to the vibration of the sensor SAx. In addition, for example, from the table shown in FIG. 10, with regard to each of a sensor SAy and a sensor SBy, it can be seen that some change which switches the vibration level is present as compared with the vibration data in the reference period.

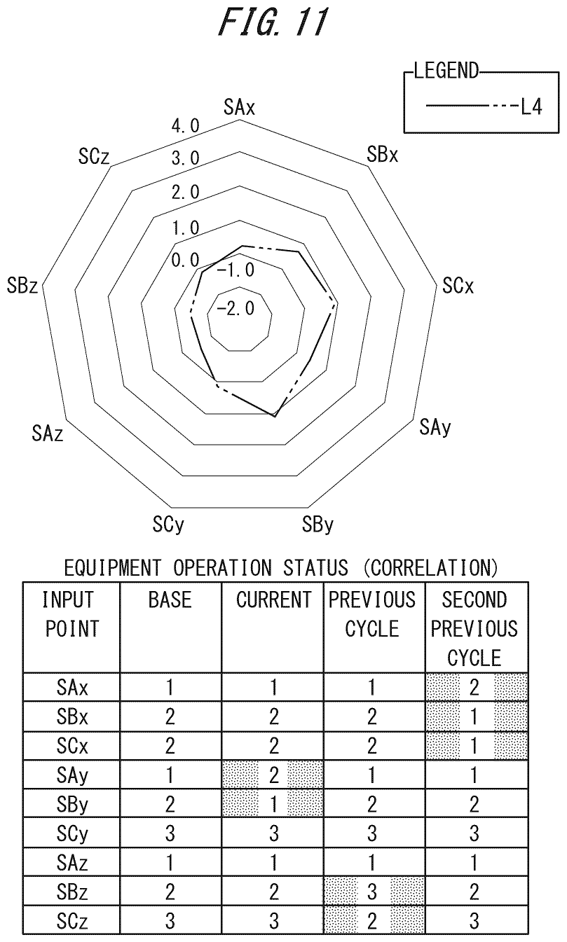

Note that the screen shown in FIG. 10 can be modified, e.g., in the following manner. FIG. 11 is a view showing a second example of the screen of the comparison result of the vibration data. The screen shown in FIG. 11 shows the degree of dispersion of only the piece of vibration data L4 in the radar chart. The radar chart showing the degree of dispersion of the vibration data may display only the vibration data in the specific period in this manner. According to this, it is possible to specifically examine the vibration data in the specific period.

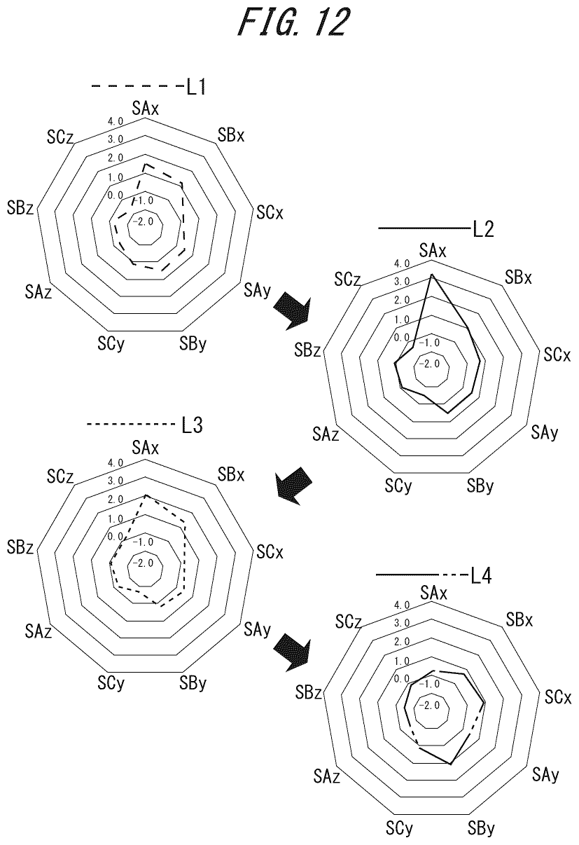

In addition, the computer 2 may display the following screen. FIG. 12 is a view showing a third example of the screen of the comparison result of the vibration data. The screen shown in FIG. 12 displays the degrees of dispersion of the pieces of vibration data L1 to L4 with four radar charts individually. In addition, the four radar charts are arranged in chronological order with arrows. When the radar charts which show the degrees of dispersion of the pieces of vibration data in the individual periods are arranged and displayed, it is possible to grasp the change of the degree of dispersion in chronological order.

Each of the screens shown as examples in FIG. 10 to FIG. 12 can also be used as, e.g., a monitoring screen of the equipment 5 in operation. In this case, by blinking and displaying the hatched display shown in FIG. 10 or the like, the change of the vibration data may be notified of the user who monitors the screen of the computer 2.

In addition, the description has been made by using the case of the vibration data as the example, but the present invention can be applied to various pieces of measurement data other than vibration.

Hereinbelow, a second embodiment will be described. The second embodiment shown below is shown by way of example only and the technical scope of the present disclosure is not limited to the following implementation.

<Hardware Configuration>

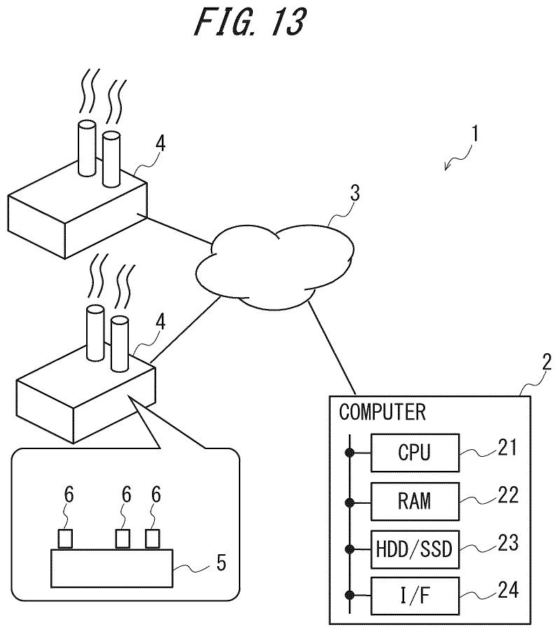

FIG. 13 is a view showing an example of the system configuration of the diagnosis system 1 according to the second embodiment. The diagnosis system 1 is a system which diagnoses the equipment 5 installed in the facility 4. The diagnosis system 1 is a system for the equipment 5 in which a plurality of processes are present in one operation cycle, and allows comparison of levels of vibration generated by the equipment 5 in a period from a start to an end in one operation cycle constituted by the plurality of processes between operation cycles. The diagnosis system 1 can be applied to, e.g., comparison before and after periodic maintenance work of the equipment 5, comparison between the time of test operation and the time of regular operation, and relative state change of vibration at other various timings. Therefore, the diagnosis system 1 acquires data related to the vibration of the equipment 5 with the temporary or permanent vibration sensor 6 mounted to the equipment 5, analyzes the data, and performs the diagnosis of the equipment 5. Examples of the equipment 5 of the facility 4 which is diagnosed by the diagnosis system 1 include various pieces of equipment which can generate vibration during operation. Examples of such equipment 5 include production equipment of medicine and industrial products, power generation equipment, transport machinery, and other various pieces of equipment.

The vibration sensor 6 which detects the vibration of the equipment 5 transmits data with wired or wireless communication. The data transmitted from the vibration sensor 6 is uploaded to the cloud 3 via a computer or the like which is installed in the facility 4. The computer 2 (an example of “diagnosis device” in the present application) analyzes the data uploaded to the cloud 3 and performs abnormality detection of the equipment 5 or the like. The computer 2 is an electronic computer having the CPU 21, the memory 22, the storage 23, and the communication interface 24, and executes various steps of processing described later by executing a computer program which is read from the storage 23 and is loaded into the memory 22. The computer 2 may be a computer installed at a place remote from the facility 4 or may also be a computer installed in the facility 4.

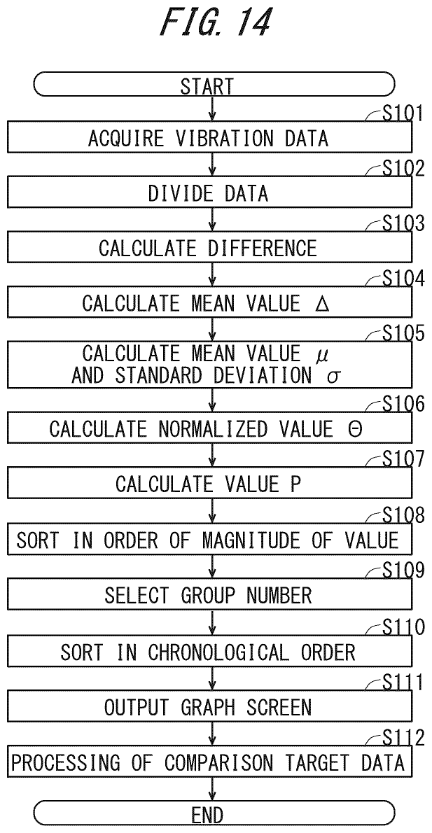

When the computer 2 executes the computer program, the computer 2 implements the following processing. FIG. 14 is a view showing an example of a processing flow implemented by the computer 2. When the computer 2 executes the computer program, the computer 2 implements a series of the processing flow from Step S101 to Step S112 shown in FIG. 14. Hereinbelow, the processing flow implemented by the computer 2 will be described.

First, the computer 2 performs acquisition of vibration data uploaded to the cloud 3 (S101). That is, the computer 2 stores vibration data measured by the vibration sensor 6 in the memory 22. The vibration data is data of a physical quantity related to vibration, and examples thereof include various vibration levels such as the magnitude of amplitude. The vibration data stored in the memory 22 may also be real-time data which is successively accumulated during operation of the computer 2. The vibration data may also be data which is transmitted directly to the computer 2 from the vibration sensor 6 instead of data uploaded to the cloud 3.

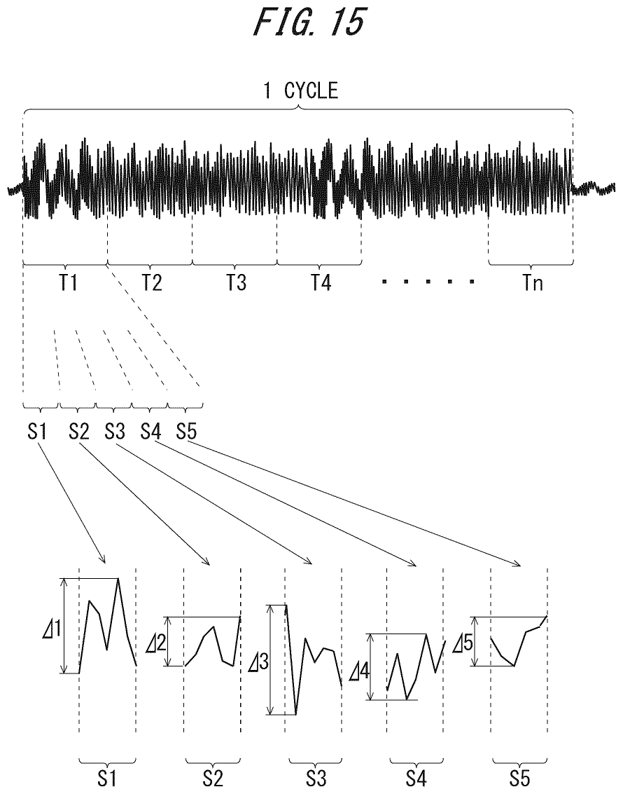

Next, the computer 2 extracts data from a start to an end of a specific operation cycle serving as a reference from vibration data, and divides the extracted vibration data into a predetermined number of pieces of vibration data (S102). FIG. 15 is a view for explaining a processing content of the vibration data in the specific operation cycle. While it is possible to determine, from among pieces of vibration data, which one of the pieces of vibration data in a certain period is to be extracted in various ways and, for example, in the case where comparison before and after periodic maintenance work is performed, it is preferable to extract, as vibration data of the operation cycle serving as the reference, vibration data from the start to the end in the operation cycle which is executed before the start of the maintenance work, or vibration data from the start to the end in the operation cycle which is executed first after completion of the maintenance work. In addition, the number of pieces of vibration data obtained by the division can be appropriately determined according to calculation ability or diagnosis accuracy of the computer 2 and, herein, a description will be made by using, as an example, the case where vibration data in a specific operation cycle is divided into n pieces of vibration data T1 to Tn. Periods in a time axis corresponding to the individual pieces of vibration data T1 to Tn are hereinafter referred to as “unit periods”.

Further, the computer 2 divides each of the pieces of vibration data T1 to Tn into a predetermined number of pieces of vibration data. The number of pieces of vibration data obtained by the division can be appropriately determined according to calculation ability or diagnosis accuracy of the computer 2 similarly to the above description and, herein, a description will be made by using, as an example, the case where each of the pieces of vibration data T1 to Tn is divided into fifths which are pieces of vibration data S1 to S5.

Next, the computer 2 calculates a difference obtained by subtracting a minimum value from a maximum value for each of the five pieces of vibration data S1 to S5 obtained by the division (S103). Hereinafter, it is assumed that the respective differences of the five pieces of vibration data S1 to S5 are differences Δ1 to Δ5. The computer 2 performs the calculation of the difference of each of the pieces of vibration data obtained by the division for, e.g., data of all of the sensors. A typical vibration sensor usually outputs pieces of vibration data of three axes of X, Y, and Z. Therefore, in the case where the vibration sensor 6 outputs the respective vibrations of the three axes in this manner, the computer 2 performs the calculation of the difference of each piece of vibration data obtained by the division for three pieces of vibration data corresponding to one vibration sensor 6. While the vibration sensor 6 outputs three pieces of vibration data in this manner, in the case where one of the outputs of the three axes which are detected by the vibration sensor 6 is meant, for the convenience of description, hereinafter, there are cases where the one of the outputs of the three axes is referred to as “the output of the sensor” or “a vibration factor”.

Next, the computer 2 calculates a mean value Δ of the differences Δ1 to Δ5 (S104). The mean value Δ is calculated for each of the pieces of vibration data T1 to Tn. Therefore, hereinafter, in the case where the mean value Δ of any of the pieces of vibration data T1 to Tn is meant, a description is made together with corresponding marks T1 to Tn (for example, the mean value Δ of the piece of vibration data T1 is described as “mean value ΔT1”). The computer 2 calculates the mean value Δ based on the following formula.

(Δ1+Δ2+Δ3+Δ4+Δ5)/5=Δ [Math. 5]

Next, the mean value p and the standard deviation σ of the vibration data in all periods in the specific operation cycle from which the data is extracted are calculated (S105). The mean value p and the standard deviation σ of the vibration data in all periods in the specific operation cycle from which the data is extracted are calculated based on the following formula. That is, the mean value p is the mean value of all of the differences Δ1 to Δ5 of the five pieces of vibration data S1 to S5 corresponding to the individual pieces of vibration data T1 to Tn (5×n pieces).

$$μ = \frac{1}{5 * n} {\sum }_{i}^{n} {\sum }_{j}^{5} {T}_{i} {Δ}_{j} \\ {σ}^{2} = \frac{1}{5 * n - 1} {\sum }_{i}^{n} {\sum }_{j}^{5} {( {T}_{i} {Δ}_{j} - μ )}^{2} \qquad [ Math . 6 ]$$

Next, the normalized values 8 of the individual pieces of vibration data T1 to Tn are calculated (S106). The normalized value Θ is calculated for each of the pieces of vibration data T1 to Tn, and hence, hereinafter, in the case where the specific normalized value Θ is meant, a description is made together with corresponding marks T1 to Tn (for example, the normalized value Θ of the piece of vibration data T1 is described as “normalized value ΘT1”). The normalized value Θ is calculated by normalizing the mean values A of the individual pieces of vibration data T1 to Tn by using the mean value p and the standard deviation σ of the vibration data in all periods in the specific operation cycle from which the data is extracted. Therefore, the computer 2 calculates the normalized value 8 based on the following formula.

$$\begin{matrix}{Θ}_{1} = \frac{{Δ}_{T 1} - μ}{σ} & … & {Θ}_{4} = \frac{{Δ}_{T 4} - μ}{σ} & … & {Θ}_{n} = \frac{{Δ}_{Tn} - μ}{σ}\end{matrix} \qquad [ Math . 7 ]$$

Next, a representative value P which indicates the state of vibration quantitatively is calculated for each of the pieces of vibration data T1 to Tn (S107). Positive and negative normalized values 8 are present in a mixed manner. Accordingly, the representative value P is assumed to be a value obtained by squaring the normalized value Θ and integrating the value obtained by the squaring with respect to all vibration factors (all sensors). Specifically, the representative value P in each unit period is calculated based on the following formula.

$$Pn = {\sum }_{m = 1}^{M} {\{ {Θ}_{n} ( m ) \}}^{2} m : vibration factor number n : cycle number \qquad [ Math . 8 ]$$

As described above, the vibration sensor 6 usually outputs three pieces of vibration data of the X-axis, the Y-axis, and the Z-axis. Therefore, in the above formula, in the case where there are three vibration sensors 6, the number of sensors M is 9 (3×3). In addition, cycle numbers are numbers of 1 to n corresponding to the pieces of vibration data T1 to Tn.

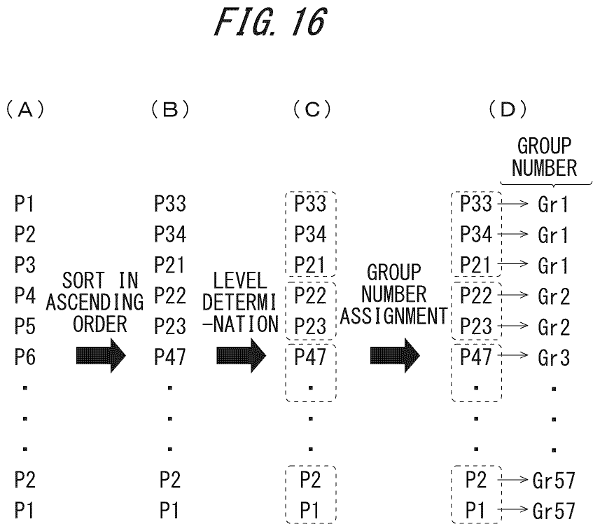

Next, the computer 2 sorts (rearranges) n representative values P in ascending order (S108). Subsequently, group numbers are selected in the order of arrangement of the representative values P (S109). The same group number is selected for, among the n representative values P, each of representative values P having the magnitudes of values which are at the same level. FIG. 16 is a view for explaining sorting of the representative values P and the assignment of the group numbers.

When the computer 2 calculates the representative values P in Step S107 as shown in FIG. 16(A), the computer 2 sorts the representative values P in ascending order in Step S108 as shown in FIG. 16(B). Subsequently, as shown in FIG. 16(C), the computer 2 performs level determination in which, among the n representative values P, the representative values P having the magnitudes of the values which are at the same level are grouped. Then, as shown in FIG. 16(D), the computer 2 selects the same group number for each of the representative values P having the magnitudes of the values which are at the same level. FIG. 16 shows an example in which three representative values P33, P34, and P21 are determined to have the magnitudes of the values which are at the same level, and the same group number “Gr1” is assigned to each of the representative values. The determination of whether or not the magnitudes of the values of the representative values P are at the same level is performed based on the following concept.

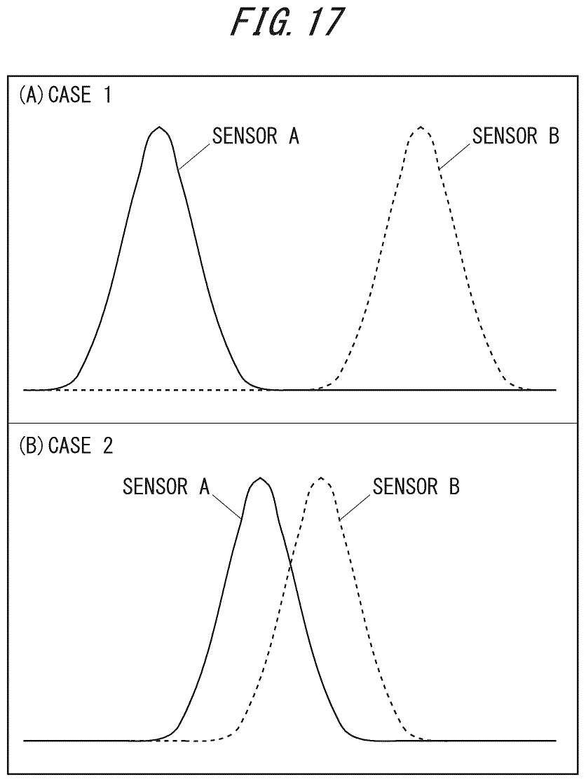

FIG. 17 is a view showing, as an example, a correlation between the magnitude of the vibration level detected by each sensor and the occurrence frequency. In each graph in FIG. 17, the horizontal axis indicates the magnitude of the vibration level, and the vertical axis indicates the occurrence frequency. In FIG. 17, the graph shown in (A) shows, as an example, the case where the magnitudes of the vibration levels detected by two sensors are clearly different from each other. In addition, in FIG. 17, the graph shown in (B) shows, as an example, the case where the magnitudes of the vibration levels detected by the two sensors are relatively close to each other. In the case where the magnitudes of the vibration levels detected by the two sensors are clearly different from each other, as shown in FIG. 17(A), it is possible to clearly determine a relative magnitude relationship between pieces of vibration data measured by the individual sensors. On the other hand, in the case where the magnitudes of the vibration levels detected by the two sensors are relatively close to each other, as shown in FIG. 17(B), there are cases where it is not possible to clearly determine the relative magnitude relationship between pieces of vibration data measured by the individual sensors. To cope with this, the determination of whether or not the magnitudes of the values of the representative values P are at the same level is performed basically in the following manner.

That is, in the case of CASE 1 shown in (A) in FIG. 17, it can be said that, in the correlation between the vibration level of a sensor A and the vibration level of a sensor B, A is clearly smaller than B (A<B). Therefore, in the present embodiment, with regard to CASE 1 in which the magnitude relationship between the vibration levels is clear, the sensor A and the sensor B are defined as different groups. In addition, in the case of CASE 2 shown in (B) in FIG. 17, it can be said that, in the correlation between the vibration level of the sensor A and the vibration level of the sensor B, there are cases where A is not more than B (A≤B) or A is not less than B (A B). Therefore, in the present embodiment, with regard to CASE 2 in which the magnitude relationship between the vibration levels is not clear, the sensor A and the sensor B are defined as the same group.

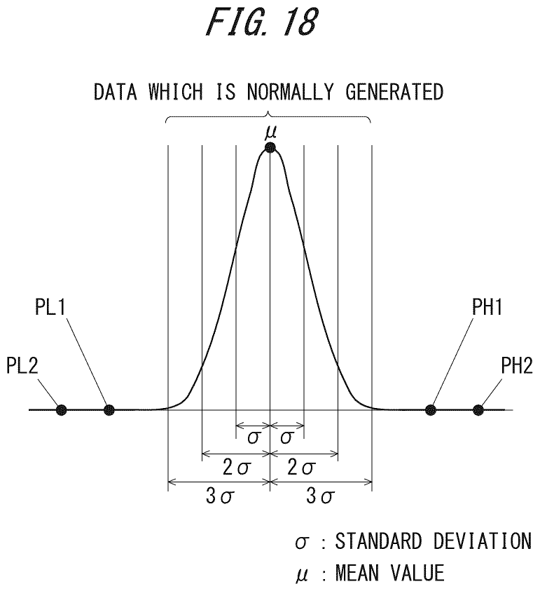

FIG. 18 is a view for explaining the concept of the correlation between the vibration levels of the sensors. In a graph in FIG. 18, the horizontal axis indicates the magnitude of the vibration level, and the vertical axis indicates the occurrence frequency. The occurrence frequency of the vibration level output by the specific sensor basically conforms to normal distribution in which the mean value μ is at the apex. Each of vibration levels PH1 and PL1 shown in the graph in FIG. 18 is data which seldom occurs (a value in a rare case). In addition, each of vibration levels PH2 and PL2 shown in the graph in FIG. 18 is abnormal data (outlier). The probability that the vibration level exceeds two standard deviations σ from the mean value μ (μ±2 σ) is 4.5%, and hence the probability that the magnitude relationship between the vibration levels of two sensors which are compared with each other is reversed is about 0.05% (2.25%×2.25%), which is an extremely low probability. To cope with this, in the present embodiment, when the value of μ+2 σ in the vibration level of the specific sensor is smaller than the value of μ−2 σ in the vibration level of another sensor, in principle, both sensors are handled as different groups.

Note that setting of a threshold value can be appropriately changed according to data of the vibration level. For example, an area in a range of ±σ is 68.3%, an area in a range of ±2 σ is 95.5%, and an area in a range of ±3 σ is 99.7%, and hence an appropriate threshold value corresponding to the number of sensors or the degree of dispersion of data of the vibration level is set as the threshold value used in grouping.

Based on the above concept, with regard to the determination of whether or not the magnitudes of the values of the representative values P calculated based on the vibration data are at the same level, specifically, the computer 2 executes the determination thereof with the following processing.

That is, for each vibration factor, the computer 2 calculates Θρobtained by normalizing the minimum value of dispersion of each of the pieces of vibration data T1 to Tn and Θη obtained by normalizing the maximum value of dispersion of each of the pieces of vibration data T1 to Tn by using the maximum value, the minimum value, the mean value, and the standard deviation of each of the pieces of vibration data S1 to S5 obtained by dividing each of the pieces of vibration data T1 to Tn into fifths in Step S102. The calculation of Θρ and Θη is performed in the following manner.

First, it is assumed that the maximum value, the minimum value, the mean value, and the standard deviation of each of the pieces of vibration data S1 to S5 are represented by η, ρ, Δ, and s in this order. In addition, for each of the pieces of vibration data S1 to S5, the minimum value Δp and the maximum value Δη of the difference in the magnitude of the dispersion of the vibration data are determined based on the following formula. Note that a coefficient s in the following formula is a value which is appropriately determined in advance according to features of the equipment 5 or the like.

if Δ−2s<ρ then Δ_{ρ}=ρ else Δ_{ρ}=Δ−2s

if Δ+2s<ρ then Δ_{η}=η else Δ_{η}=Δ+2s [Math. 9]

Next, for each vibration factor, the mean value μ and the standard deviation σ of all of the pieces of vibration data S1 to S5 in the operation cycle, i.e., (5×3×n) A are calculated. Subsequently, Θρ obtained by normalizing Δρ in each unit period and Θη obtained by normalizing Δη in each unit period are calculated by using the calculated mean value μ and the calculated standard deviation σ. Specifically, Θρ and Θη are calculated based on the following formula.

$$\begin{matrix}Θρ = \frac{{Δ}_{ρ} - μ}{σ} & Θη = \frac{{Δ}_{η} - μ}{σ}\end{matrix} \qquad [ Math . 10 ]$$

Positive and negative normalized values can be present in a mixed manner. To cope with this, similarly to the calculation of the representative value P, the minimum representative value Pρ and the maximum representative value Pη which are obtained by squaring the calculated Θρ and the calculated Θη and integrating the values obtained by the squaring with respect to all vibration factors (all sensors) are calculated. Specifically, the representative values Pp and Ph in each unit period are calculated based on the following formula.

### [Math. 11]

Subsequently, after the representative values P are sorted in ascending order in Step S108, level determination in which the representative values P whose ranges between the representative values Pp and the representative values Ph, which correspond to the individual representative values P, overlap each other are determined to be at the same level is performed, and processing in Step S109, i.e., processing of selecting group numbers is completed. A formula representing a method of the determination of whether or not the representative values are at the same level is described below. The following formula shows, as

$$P ρ n = {\sum }_{m = 1}^{M} {\{ {Θ}_{ρ n} ( m ) \}}^{2} m : vibration factor No . n : cycle No . \\ P η n = {\sum }_{m = 1}^{M} {\{ {Θ}_{η n} ( m ) \}}^{2} m : vibration factor No . n : cycle No .$$

an example, the case where, as a result of sorting the representative values P in ascending order, “P41<P53<P40< . . . ” is satisfied. When it is assumed that the group number of the representative value Pn is Gn, the group numbers are selected according to a determination criterion shown in the following formula.

G41=1

if Pη41 <Pρ53 then G53=2 else G53=1

if G53=1 & Pη53<Pρ40 then G40=2 else G40=1

if G53=2 & Pη53<Pρ40 then G40=3 else G40=2 [Math. 12]

That is, the above formula shows an example in which “1” is set as a group number G41 of a representative value P41 which is one of n representative values P and has the smallest value. In addition, the above formula shows an example in which, when Pη41 corresponding to the representative value P41 is smaller than a representative value Pρ53 corresponding to a representative value P53 which is a value immediately larger than the representative value P41, it follows that a range between the minimum representative value Pρ41 and the maximum representative value Pη41 corresponding to the representative value P41 does not overlap a range between the minimum representative value Pρ53 and the maximum representative value Pri53 corresponding to the representative value P53, and hence it is determined that the representative value P53 is not at the same level as that of the representative value P41, and “2” is set as a group number G53 of the representative value P53. Further, the above formula shows an example in which, when the maximum representative value Pη41 corresponding to the representative value P41 is not less than the minimum representative value Pρ53 corresponding to the representative value P53 which is the value immediately larger than the representative value P41, it follows that the range between the minimum representative value Pρ41 and the maximum representative value Pη41 corresponding to the representative value P41 overlaps the range between the minimum representative value Pρ53 and the maximum representative value Pη53 corresponding to the representative value P53, and hence it is determined that the representative value P53 is at the same level as that of the representative value P41, and “1” which is identical to the group number G41 of the representative value P41 is set as the group number G53 of the representative value P53.

With the processing described above, the selection of the group numbers is completed for each of n representative values P.

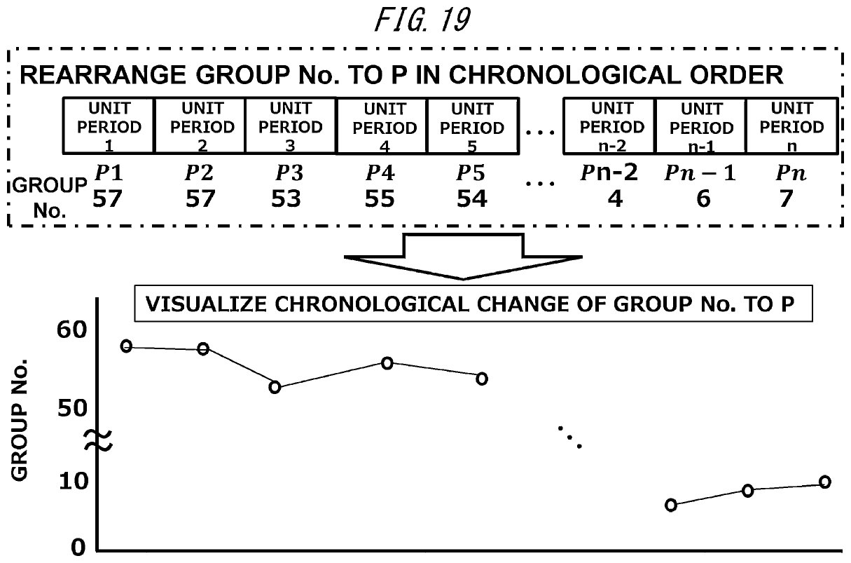

Next, the computer 2 sorts the selected group numbers in chronological order of pieces of vibration data corresponding to the individual group numbers (S110). Subsequently, the computer 2 creates a graph in which the horizontal axis indicates a time series and the vertical axis indicates the group number (S111). FIG. 19 is a view in which sorting of the group numbers in a specific operation cycle and drawing processing of the graph are imaged. When the computer 2 executes processing in Step S110, for example, as shown in FIG. 19, the group numbers are sorted in chronological order so as to correspond to the individual unit periods of the pieces of vibration data T1 to Tn. Therefore, when the group numbers which are sorted in chronological order are plotted in the graph in which the vertical axis indicates the group number, as shown in FIG. 19, the graph which visually represents the group numbers selected in Step S109 in chronological order is completed. Hereinafter, a pattern indicated by a polygonal line of the graph is referred to as a base pattern.

Next, the computer 2 checks the base pattern representing features of vibration data in a reference operation cycle against a comparison target pattern representing features of vibration data in a comparison target operation cycle. Specifically, the computer 2 executes the following processing, and processes the vibration data in the comparison target operation cycle (S112).

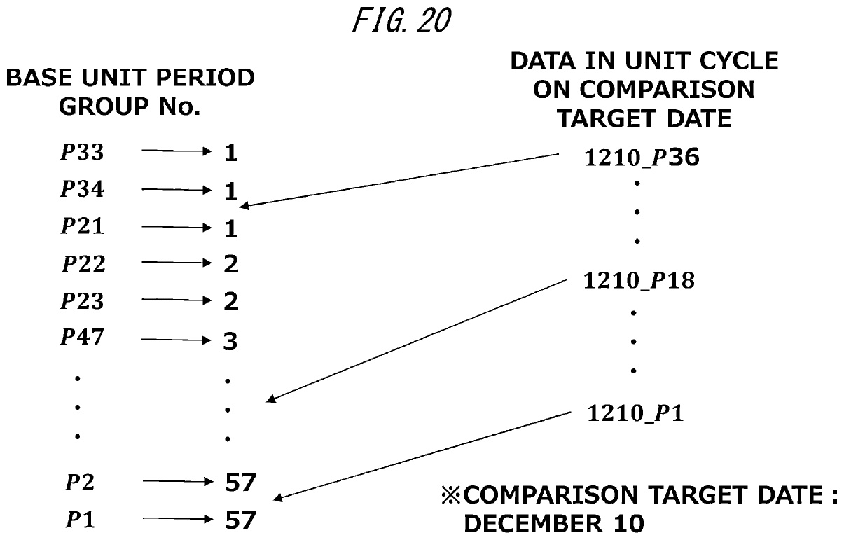

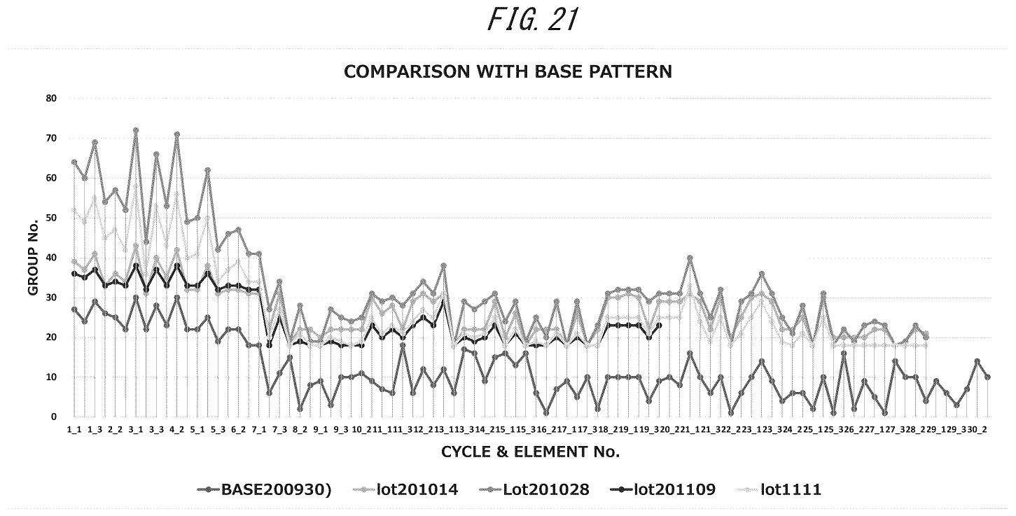

That is, first, the computer 2 calculates the representative value P from the vibration data in the comparison target operation cycle. A calculation method is the same as the above-described processing in Step S102 to Step S107. Next, the representative value P calculated from the vibration data in the reference operation cycle and the representative value P calculated from the vibration data in the comparison target operation cycle are mixed. FIG. 20 is a view in which mixing processing is represented with an image. Next, the computer 2 performs the same processing as that in Step S108 to Step S109 on the mixed representative values P, and selects group numbers. Subsequently, the computer 2 groups the selected group numbers into group numbers corresponding to the reference operation cycle and group numbers corresponding to the comparison target operation cycle. Then, the computer 2 performs the same processing as that in Step S110 on each of the grouped group numbers, and sorts the group numbers corresponding to the reference operation cycle and the group numbers corresponding to the comparison target operation cycle in chronological order of pieces of the vibration data corresponding to the individual group numbers. Subsequently, similarly to Step S111, the computer 2 creates a graph in which the horizontal axis indicates the time series and the vertical axis indicates the group number. FIG. 21 is a graph in which a graph of the comparison target operation cycle is shown such that the graph can be compared with the base pattern.

The graph in FIG. 21 shows, in addition to a graph of the base pattern showing a reference specific operation cycle, graphs of four operation cycles as comparison targets. In the graph in FIG. 21, the group number indicated by the vertical axis is irrelevant to the magnitude of the vibration level. As a deviation from the mean value of the difference of the magnitude of a vibration value is larger, dispersion indicated by a graph line is increased. In an example shown in FIG. 21, by comparing five graph lines, it can be seen that, at an initial stage of a start of each operation cycle, the deviation from the mean value of the difference of the magnitude of the vibration value is large. For example, in the case where the equipment 5 has a process of performing vacuuming of a vacuum chamber with a vacuum pump at the initial stage of the start of the operation cycle, the vibration level generated by the vacuum pump changes according to a valve opening degree on a suction side of the vacuum pump and a sealing degree of an opening-closing portion of the vacuum chamber. Therefore, in the case of such equipment 5, as shown in FIG. 21, there are cases where the deviation from the mean value of the difference of the magnitude of the vibration value is increased at the initial stage of the start of each operation cycle.

Thus, the computer 2 of the present embodiment outputs a screen of the graph capable of visually grasping the deviation from the mean value of the difference of the magnitude of the vibration value. Therefore, according to the diagnosis system 1, even in the case of the equipment 5 in which a plurality of processes are present in one operation cycle, it is possible to compare levels of the vibration generated by the equipment 5 in a period from a start to an end in one operation cycle between the individual operation cycles. Consequently, a manager of the equipment 5 can use the graph as a reference when the equipment 5 is examined or it is determined whether or not maintenance is necessary.

Note that, while the description has been made by using the case of the vibration data as the example in the present embodiment, the present invention can also be applied to various pieces of measurement data other than the vibration.

<Computer-Readable Recording Medium>

It is possible to record a program which causes a computer, other machines, or a device (hereinafter, a computer or the like) to implement any of the functions described above in a recording medium which can be read by the computer or the like. In addition, it is possible to cause the computer or the like to provide the function by causing the computer or the like to read and execute the program in the recording medium.

Herein, the recording medium which can be read by the computer or the like denotes a recording medium which can store information such as data or a program by electrical, magnetic, optical, mechanical, or chemical action and read the information from the computer or the like. Examples of such a recording medium which can be detached from the computer or the like include a flexible disk, a magneto-optical disk, a CD-ROM, a CD-R/W, a DVD, a Blu-ray disk (Blu-ray is a registered trademark), a DAT, an 8 mm tape, and a memory card such as a flash memory. In addition, examples of a recording medium fixed to the computer or the like include a hard disk and a ROM (read-only memory).

### DESCRIPTION OF SYMBOLS

1 Diagnosis system
2 Computer
3 Cloud
4 Facility
5 Equipment
6 Vibration sensor
21 CPU
22 Memory
23 Storage
24 Communication interface

What is claimed is:

1. A diagnosis device for diagnosing a status of equipment, comprising:
a memory which stores time series data of a plurality of sensors indicative of the status of the equipment; and
a processor which determines change of the status of the equipment from the time series data, wherein
the processor executes:
processing of determining a mean value and a standard deviation of reference data which is data in a reference period in the time series data and then calculating a normalized value of comparison data which is data in a comparison target period in the time series data from the mean value and the standard deviation;
processing of executing processing of grouping pieces of data of the plurality of sensors in order of a magnitude relationship between the pieces of data for each of the reference data and the comparison data; and
processing of outputting a screen having a diagram which visually shows the normalized value of the comparison data and a table which represents a correspondence between ranking of a group of the magnitude relationship between the pieces of data and each of the plurality of sensors for each of the reference data and the comparison data.

2. The diagnosis device according to claim 1, wherein
the sensor is a vibration sensor, and
the time series data is data of a vibration level of the equipment.

3. The diagnosis device according to claim 1, wherein
the processor divides the reference data into a predetermined number of pieces of the reference data and divides the comparison data into a predetermined number of pieces of the comparison data, and calculates the mean value and the standard deviation of the reference data and the normalized value of the comparison data from the mean value and the standard deviation of the reference data and a difference between a maximum value and a minimum value of the pieces of the data in each division period.

4. The diagnosis device according to claim 1, wherein
the processor executes, for each of the reference data and the comparison data, processing of grouping in the order of the magnitude relationship between the pieces of data by grouping the plurality of sensors into a same group and a different group according to whether or not the pieces of data of the plurality of sensors fall within a range having a standard deviation in normal distribution as a reference.

5. A diagnosis method for diagnosing a status of equipment, wherein
a computer executes:
processing of determining a mean value and a standard deviation of reference data which is data in a reference period in time series data of a plurality of sensors indicative of the status of the equipment and then calculating a normalized value of comparison data which is data in a comparison target period in the time series data from the mean value and the standard deviation;
processing of executing processing of grouping pieces of data of the plurality of sensors in order of a magnitude relationship between the pieces of data for each of the reference data and the comparison data; and
processing of outputting a screen having a diagram which visually shows the normalized value of the comparison data and a table which represents a correspondence between ranking of a group of the magnitude relationship between the pieces of data and each of the plurality of sensors for each of the reference data and the comparison data.

6. A non-transitory computer-readable recording medium having stored therein a diagnosis program for diagnosing a status of equipment which causes a computer to execute:
processing of determining a mean value and a standard deviation of reference data which is data in a reference period in time series data of a plurality of sensors indicative of the status of the equipment and then calculating a normalized value of comparison data which is data in a comparison target period in the time series data from the mean value and the standard deviation;
processing of executing processing of grouping pieces of data of the plurality of sensors in order of a magnitude relationship between the pieces of data for each of the reference data and the comparison data; and
processing of outputting a screen having a diagram which visually shows the normalized value of the comparison data and a table which represents a correspondence between ranking of a group of the magnitude relationship between the pieces of data and each of the plurality of sensors for each of the reference data and the comparison data.

7. A diagnosis device for diagnosing a status of equipment in which a plurality of processes are present in one operation cycle, the diagnosis device comprising:
a memory which stores time series data of a plurality of sensors indicative of the status of the equipment; and
a processor which determines change of the status of the equipment from the time series data, wherein
the processor executes:
calculation processing of dividing data from a start to an end of a specific operation cycle in the time series data for each of unit periods and calculating a representative value indicative of a relative relationship of data in each unit period to data in all periods in the specific operation cycle for each of the unit periods;
grouping processing of assigning a group number which is selected in order of magnitude of the representative value to the data in each of the unit periods; and
output processing of outputting a screen of a graph in which a plurality of graphs which are obtained by plotting the group number assigned to the data in each of the unit periods in chronological order of each of the unit periods and correspond to a plurality of operation cycles are shown so as to overlap each other.

8. The diagnosis device according to claim 7, wherein the processor calculates a value obtained by squaring a normalized value indicative of magnitude of a degree of dispersion of the data in each of the unit periods and totalizing the value obtained by the squaring which corresponds to the plurality of sensors as the representative value for each of the unit periods in the calculation processing.

9. The diagnosis device according to claim 8, wherein
the processor calculates a mean value Δ of each of the unit periods for a difference between a maximum value and a minimum value which are calculated individually after the data in each of the unit periods is divided into a predetermined number of pieces of the data and all mean values p and all standard deviations σ in the specific operation cycle, and calculates the normalized value by using the mean value Δ, the mean values μ, and the standard deviations σ.

10. The diagnosis device according to claim 7, wherein
the processor determines that the representative values of pieces of data in a specific unit period which is one of the individual unit periods and pieces of data in another specific unit period whose ranges between minimum values and maximum values of differences of magnitude of dispersion of the pieces of data overlap each other are at a same level, and assigns a same group number to each of the pieces of data of the unit periods in the grouping processing.

11. The diagnosis device according to claim 7, wherein
each of the plurality of sensors is a vibration sensor, and
the time series data is data of a vibration level of the equipment.

12. A diagnosis method for diagnosing a status of equipment in which a plurality of processes are present in one operation cycle, wherein
a computer executes:
calculation processing of dividing data from a start to an end of a specific operation cycle in time series data of a plurality of sensors indicative of the status of the equipment for each of unit periods and calculating a representative value indicative of a relative relationship of data in each unit period to data in all periods in the specific operation cycle for each of the unit periods;
grouping processing of assigning a group number which is selected in order of magnitude of the representative value to the data in each of the unit periods; and
output processing of outputting a screen of a graph in which a plurality of graphs which are obtained by plotting the group number assigned to the data in each of the unit periods in chronological order of each of the unit periods and correspond to a plurality of operation cycles are shown so as to overlap each other.

13. A non-transitory computer-readable recording medium having stored therein a diagnosis program for diagnosing a status of equipment in which a plurality of processes are present in one operation cycle, the diagnosis program causing a computer to execute:
calculation processing of dividing data from a start to an end of a specific operation cycle in time series data of a plurality of sensors indicative of the status of the equipment for each of unit periods and calculating a representative value indicative of a relative relationship of data in each unit period to data in all periods in the specific operation cycle for each of the unit periods;
grouping processing of assigning a group number which is selected in order of magnitude of the representative value to the data in each of the unit periods; and
output processing of outputting a screen of a graph in which a plurality of graphs which are obtained by plotting the group number assigned to the data in each of the unit periods in chronological order of each of the unit periods and correspond to a plurality of operation cycles are shown so as to overlap each other.
